(19) United States
(12) Patent Application Publication
(10) Pub. No.: US 2023/0308971 A1
(43) Pub. Date: Sep. 28, 2023

(54) METHODS AND APPARATUS FOR SUPPORTING SWITCHING OF TRAFFIC CORRESPONDING TO A COMMUNICATION SESSION BETWEEN TWO NON-3GPP ACCESS PATHS

(71) Applicant: Charter Communications Operating, LLC, St. Louis, MO (US)

(72) Inventors: Curt Wong, Bellevue, WA (US); Yildirim Sahin, Englewood, CO (US); Umamaheswar Kakinada, Greenwood village, CO (US)

(21) Appl. No.: 17/700,919

(22) Filed: Mar. 22, 2022

(51) Int. Cl. H04W 36/08; H04W 36/00

(52) U.S. Cl. CPC H04W 36/08; H04W 36/0011

(57) ABSTRACT

Methods and apparatus for supporting switching of data paths corresponding to a communications session between different non-3GPP access networks, e.g., networks including WiFi access points, using network core functionality are described. This allows a communications session in which a UE is involved as an end point to be switched between two different WiFi access networks and/or a WiFi access network and a 3GPP access network, e.g., cellular access network, without the communications session being terminated while service is provided to the UE by a Public Land Mobile Network (PLMN) with which it is registered. A UE can switch between multiple WiFi networks while maintaining a communications session supported by network core functionality even though the session may be switched between different non-3GPP networks while the session is ongoing.

### FIELD

The present application relates to supporting communications using multiple networks and, more particularly, supporting switching of traffic corresponding to a communications session between network access paths, e.g., between multiple non-3GPP access paths such as access paths which use WiFi access points of different networks.

### BACKGROUND

3GPP functionality has been developed to support switching between use of a 3GPP access network, e.g., a cellular network which uses a 3GPP cellular base station to support network access, and a non-3GPP (N3GPP) access network such as a WiFi based network. Unfortunately, switching between non-3GPP networks is not supported. This can cause a session to be dropped as a user equipment (UE) moves out of range of a first WiFi network or may involve switching back to a 3GPP network base station. This currently tends to be the case even if another, e.g., second WiFi network is available at the point where the UE begins to lose connectivity to the first WiFi Access point.

It would be desirable if network communications core functionality could be developed which would allow communications to be directedly switched between non-3GPP access networks, e.g., WiFi access networks. In addition, it would be desirable if such switching could be implemented in a network core using network functionally that also supports 3GPP network access and/or switching of a communications session between a 3GPP access network and a non-3GPP access network.

Accordingly, it should be appreciated that there is a need for improved methods and/or apparatus for supporting a communications session while allowing the session to switch between using traffic data paths of different non-3GPP access networks and/or switching between a data path of a 3GPP access network and a data path of a non-3GPP access network without the session being terminated and a new session having to be established.

### SUMMARY

Methods and apparatus for supporting switching of data paths corresponding to a communications session between different non-3GPP access networks, e.g., networks including WiFi access points, using network core functionality are described. This allows a communications session in which a UE is involved as an end point to be switched between two different WiFi access networks and/or a WiFi access network and a 3GPP access network, e.g., cellular access network, without the communications session being terminated while service is provided to the UE by a Public Land Mobile Network (PLMN) with which it is registered. A UE can switch between multiple WiFi networks while maintaining a communications session supported by network core functionality even though the session may be switched between different non-3GPP networks while the session is ongoing.

In various embodiments functions of the PLMN are implemented in a corresponding network core using one or more processors. Interfaces to the processors can and sometimes do include receivers and/or transmitters. Accordingly, while one or more elements are described in the present application as “functions”, it should be appreciated that these functions are implemented on hardware, e.g., one or more processors with interfaces to support receiving and/or sending of signals. Thus, the functions of a PLMN are hardware implemented functions in at least some embodiments. The processor or processor used to implement a function are, in some cases, part of what is referred to as a cloud network or network cloud. 5G functions are well suited for implementation in network clouds, and thus some embodiments are implemented using a network cloud based approach to function implementation.

In one exemplary embodiment, a UE discovers a N3GPP access network, e.g., a first WiFi network, and performs a registration, e.g., a 5G registration to a Public Land Mobile Network (PLMN) which provides service to the UE. In one such embodiment the UE receives a Global Unique Temporary Identifier (GUTI), e.g., a 5G-GUTI, from an Access and Mobility Management Function (AMF), e.g., a 5G AMF, in the PLMN network core. The UE then generates a session ID, e.g., a PDU session ID number, e.g., session ID #A, and communicates to a Session Management Function (SMF), e.g., a 5G SMF, a request to create a session, e.g., a multi-access (MA) protocol data unit (PDU) session corresponding to the session ID number. In response to receiving the session establishment request, the SMF checks service information corresponding to the user device, e.g., Unified Data Management (UDM) subscription information to ensure that the requested session, e.g., MA PDU session, is allowed. If not allowed the session will be denied, but assuming the UE is entitled to have the requested session, the SMF proceeds to check with a Policy Control Function (PCF) to determine what Access Traffic Steering, Switching and Splitting (ATSSS) policy should be applied to the session being established for the UE.

In accordance with one feature of the invention the ATSSS policy information indicates that N3GPP path switching, e.g., switching between data paths corresponding to different N3GPP access networks, e.g., different WiFi access networks, is to be supported for the session being established. Since the policy rules applicable to the UE indicate that N3GPP path switching is to be supported by the PLMN for the session being established, the SMF indicates to the User Plane Function (UPF), of the PLMN, that will be used to support the session that it is to perform an ATSSS function that supports path switching for the session being established. Since the PLMN in the exemplary embodiments support N3GPP path switching which allows for direct switching between different N3GPP access networks, this information is sent back to the UE as part of a MA PDU session accept message. The PDU session accept message includes a link specific address (e.g., address #1) for the session identified by the user device generated PDU session ID number. The PDU session accept message also includes information indicating that N3GPP path switching is supported for the established session.

The UE receives the MA PDU session accept message with the link specific address (address #1) for the path (path 1) corresponding to the first non-3GPP access network along with ATSSS rule information and an indication that N3GPP path switching is supported for the session corresponding to the session ID (session ID #A).

As the UE moves, in some cases it will discover a new N3GPP access network, e.g., a second WiFI access network. In at least some cases the UE will register with the PLMN from which it receives service, via the second access network, using the Global Unique Temporary Identifier, e.g., 5G-GUTI, which it was previously supplied with by the PLMN. Once registered via the second N3GPP access network, e.g., second WiFi network, the UE may and sometimes does request a session, e.g., an MA PDU session, via the second access network so that it can use the second access network for the already established session identified by the UE generated session ID (ID #A) which was used to establish the session via the first non-3GPP access network. To indicate that the requested session is for the previously established session, e.g., the session identified by session ID #A, the UE includes in the session establishment request sent to the PLMN via the second N3GPP access network the previously generated session identifier, e.g., session ID #A, that the UE used to establish the session via the first N3GPP access network.

The AMF in the PLMN recognizes the session ID (session ID #A) corresponding to the UE received session establishment request as corresponding to the UE session that was established via the first N3GPP access network and causes, e.g., triggers, the same AMF that handled session establishment request for the UE for the previous request including the session ID (session ID #A) to indicate to the SMF that a new N3GPP path corresponding to the second N3GPP access network is to replace the existing N3GPP path for the identified session (e.g., MA PDU session corresponding to Session ID #A). The SMF then checks the PCF in the PLMN for additional ATSSS policy information, if any, that will be applicable and the SMF may generate new ATSSS rules if needed. The SMF then indicates to the UPF that it should perform one or more ATSSS related functions such as, for example, generate a second link specific address (e.g., address #2) for the traffic path via the second N3GPP access network and corresponding N3 tunnel information while also indicating that the new N3 tunnel is to replace the N3 tunnel previously established for the path through the first N3GPPP access network.

A session accepted message is communicated from the AMF of the PLMN providing service to the UE, thereby informing the UE of the establishment of the path through the second N3GPP access network. This is a second path (path #2) for the session corresponding to the UE generated session identifier session ID #A. The UE receives the session accepted message which includes the link specific address (e.g. address #2) for the path through the second NG3PP access network and the UE then uses this new established path, the second path, for data path transmission in the session, e.g., MA PDU session, identified by the UE generated session identifier A.

After the UE has switched the MA PDU session path from the first path through the first N3GPP access network to the second path through the second N3GPP access network, the UE can, and sometimes does, initiate release of an N1 connection associated with the first path by performing a deregistration operation with respect to the first non-3GPP access network with the AMF or the AMF may, and sometimes does initiate de-registration of the UE with regard to the first non-3GPP access network once it becomes aware that the second data path has been successfully established via the second access network and/or that the session has been switched to the path through the second non-3GPP access network.

While a single switch between two non-3GPP access network is described, the switch procedure can be implemented multiple times allowing for multiple sequential switches between different non-3GPP access networks without a PLMN having to drop or terminate an ongoing session. Similarly switches to/from a 3GPP access network can and sometimes are supported.

While discussed in terms of 5G terminology it should be appreciated that the methods and apparatus can be used with other communications standards and systems which support the same or similar functionality.

Numerous variations on the above described methods and embodiments will be discussed in the detailed description which follows.

### BRIEF DESCRIPTION OF THE FIGURES

FIG. 1 is a drawing of an exemplary communications system in accordance with an exemplary embodiment.

FIG. 2A is a first part of a drawing illustrating exemplary signaling and operations of an exemplary communications method, in which traffic of a MA PDU session is switched between two non-3GPP access paths, in accordance with an exemplary embodiment.

FIG. 2B is a second part of a drawing illustrating exemplary signaling and operations of an exemplary communications method, in which traffic of a MA PDU session is switched between two non-3GPP access paths, in accordance with an exemplary embodiment.

FIG. 2C is a third part of a drawing illustrating exemplary signaling and operations of an exemplary communications method, in which traffic of a MA PDU session is switched between two non-3GPP access paths, in accordance with an exemplary embodiment.

FIG. 2 comprises the combination of FIG. 2A, FIG. 2B and FIG. 2C.

FIG. 3 is a drawing of an exemplary user equipment (UE) with access traffic steering switching & splitting (ATSSS) functionality in accordance with an exemplary embodiment.

FIG. 4 is a drawing of an exemplary system, e.g., a server or cloud based processing system including an access and mobility management function (AMF), a session management function (SMF), a unified data management (UDM), a policy control function (PCF) and/or user plane function (UPF) with ATSSS functionality, or a data network (DN) server, which can be part of a PLMN or to implement PLMN functionality in accordance with an exemplary embodiment.

FIG. 5 is drawing of an exemplary access point (AP) such as a WiFi AP, e.g., an untrusted network AP or a trusted network access point (TNAP), in accordance with an exemplary embodiment.

### DETAILED DESCRIPTION

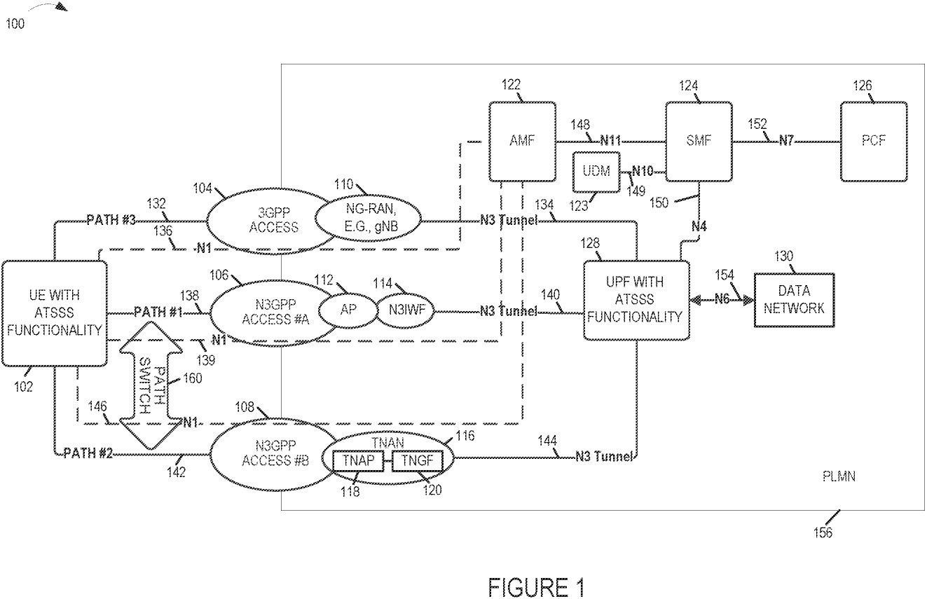

FIG. 1 is a drawing of an exemplary communications system 100 in accordance with an exemplary embodiment. Exemplary communications system 100 includes a UE 102 with ATSSS functionality, a 3rd generation partnership project (3GPP) radio access network (RAN) 104, a first non-3GPP (N3GPP) radio access network, which is N3GPP radio access network #A 106, a second N3GPP radio access network, which is N3GPP radio access network #B 108, a AMF 122, a UDM 123, a SMF 124, a PCF 126, a UPF 128 with ATSSS functionality, and a data network (DN) 130 coupled together as shown.

3GPP radio access network 104 including a NG-RAN 110 including, e.g., a gNB base station. N3GPP radio access network #A 106 includes an access point (AP) 112, e.g., a untrusted WiFi AP, coupled to a Non-3GPP Interworking Function (N3IWF) 114. N3GPP radio access network #B 108 includes a trusted Non-3GPP access network (TNAN) 116 including a Trusted Non-3GPP Access Point (TNAP) 118 and a trusted Non-3GPP Gateway Function (TNGF) 120.

UE 102 is coupled to 3GPP radio access network 104 via wireless path #3 132. UE 102 is coupled to N3GPP radio access network #A 106 via wireless path #1 138. UE 102 is coupled to N3GPP radio access network #B 108 via wireless path #2 142. N3 tunnel 134 couples 3GPP radio access network 104 to UPF 128. N3 tunnel 140 couples N3GPP radio access network #A 106 to UPF 128. N3 tunnel 144 couples N3GPP radio access network #B 106 to UPF 128.

N1 connection 136 couples UE 102 to AMF 122, via 3GPP access radio network 104. N1 connection 139 couples UE 102 to AMF 122, via N3GPP radio access network #A 106. N1 connection 146 couples UE 102 to AMF 122, via N3GPP radio access network #B 108. N11 connection 148 couples AMF 122 to SMF 124. N7 connection 152 couples SMF 124 to PCF 126. N10 connection 149 couples UDM 123 to SMF 124. N4 connection 150 couples SMF 124 to UPF 128. N6 connection 154 couples UPF 128 to data network 130.

The 3GPP access network 104, AMF 122, UDM 123, SMF 124, PCF 126, UPF 128, and data network 130 are part of the same public land mobile network (PLMN) 156.

Large arrow 160 indicates that the access path for traffic data can be, and sometimes is, switched between path #1 138 (corresponding to a first N3GPP access network) and path #2 142 (corresponding to a second N3GPP access network), while maintaining an ongoing multi-access (MA) communications session including path #3 (corresponding to the 3GPP access network 104), in accordance with the exemplary embodiment.

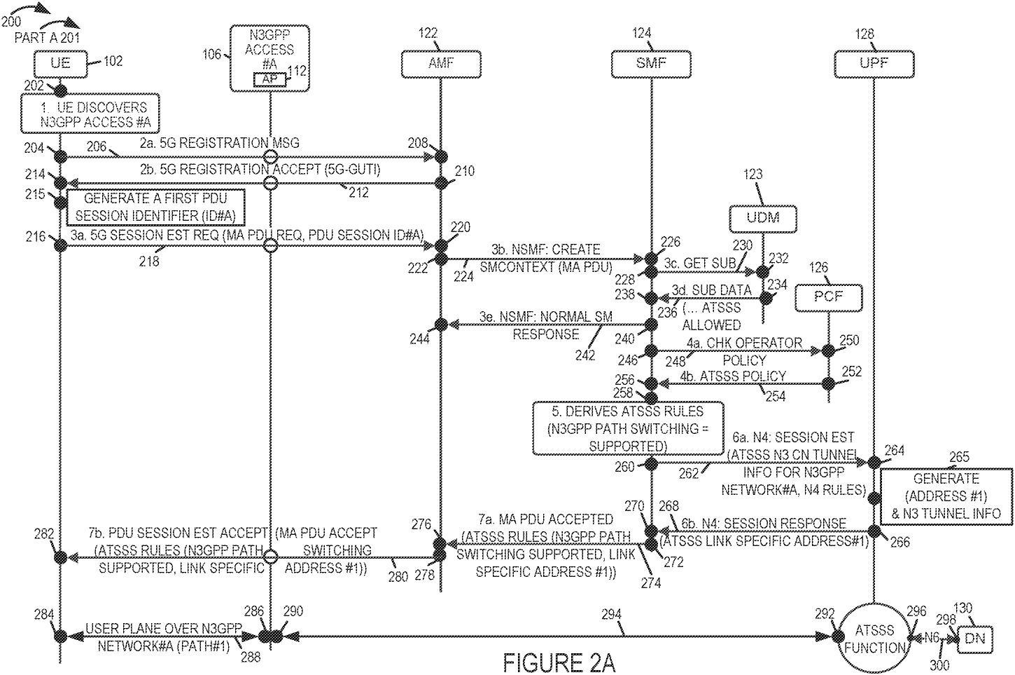

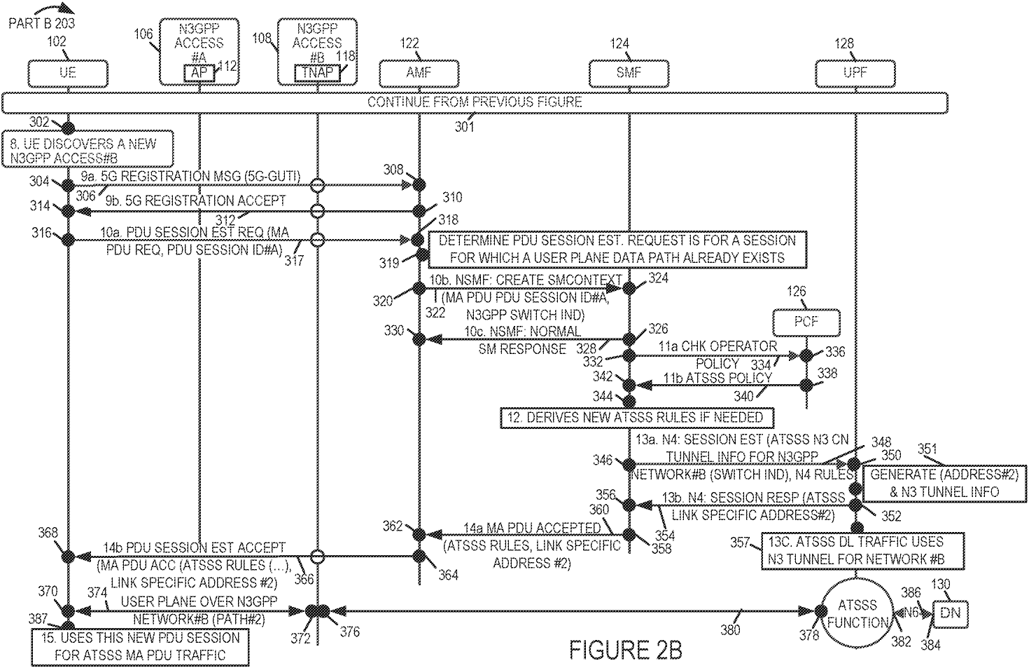

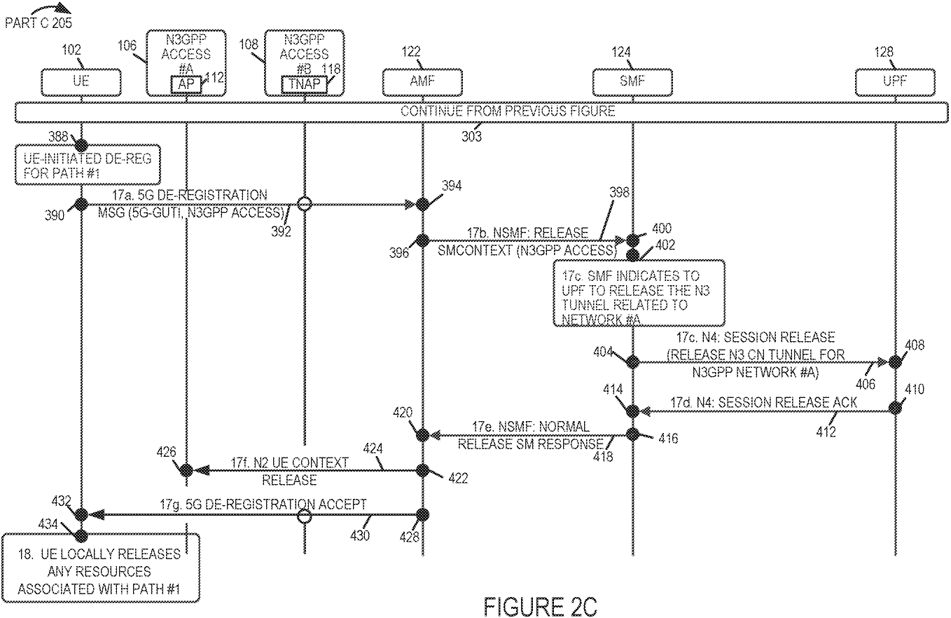

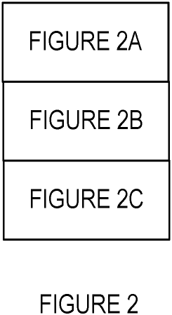

FIG. 2, comprising the combination of FIG. 2A, FIG. 2B and FIG. 2C, is drawing 200, comprising the combination of Part A 201, Part B 203 and Part C 205, illustrating exemplary signaling and operations of an exemplary communications method in accordance with an exemplary embodiment. Drawing 201 of FIG. 2A illustrates UE 102 establishing a first N3GPP access path #1 138. Drawing 203 of FIG. 2B illustrates UE 102 establishing 2nd N3GPP access path #2 142 and switching of data transmission from path 1 to path 2. Drawing 205 FIG. 2C illustrates de-registration of path #1 and the release of resources related to path #1.

In step 202, the UE 102 discovers N3GPP access network #A 106, e.g., a first WiFi network. Operation proceeds from step 202 to step 204.

In step 204, the UE performs 5G registration to the PLMN. Thus, in step 204, the UE 102 generates and sends, via N3GPP access #A, a registration message 206 to AMF 122 of PLMN 156. In step 208 the AMF 122 receives the 5G registration message 206, and in response, in step 210 the AMF allocates a 5G (NR) Global Unique Temporary Identifier (5G-GUTI) to the UE 102, and generates and sends, via the N3GPP access #A, a 5G registration accept message 212 including the AMF allocated 5G-GUTI. In step 214 UE 102 receives the 5G registration accept message 212 and recovers the 5G-GUTI.

In step 215, the UE 102 generates a PDU session ID, which is ID#A.

In step 216, in response to the received registration accept message 212, the UE 102 generates and sends, via N3GPP access #A, a request for a multi-access (MA) protocol data unit (PDU) session to the AMF 122. Thus, in step 216, the UE 102 sends 5G session request 218 including MA PDU request and PDU session ID#A.

In step 220 the AMF 122 receives the 5G session request message 218 including the MA PDU request and the PDU session identifier ID#A. In step 222 the AMF 122 generates and sends NSMF: Create SMContext (MA PDU) message 224 to SMF 124, requesting the SMF 124 to create a PDU session.

In step 226 the SMF 124 receives message 226, and in response, in step 228 the SMF 124 generates and sends get subscriber (SUB) information message 230 to the UDM 123. The SMF 124 is checking with the UDM subscription to ensure a MA PDU session is allowed. In step 232, the UDM 123 receives the get subscriber information message 230, and in response, in step 234, the UDM 123, retrieves stored subscriber information, and generates and sends Subscriber (SUB) data (.... ATSSS allowed) message 236 to SMF 124, which includes information indicating that ATSSS is allowed (MA PDU session is allowed). In step 240, the SMF 124, generates and sends NSMF: normal SM response message 242 to AMF 122.

In step 246 the SMF 124 generates and sends check operator policy message 248 to PCF 126 to check for any additional ATSSS policy if any. In step 250 the PCF 126 receives the check policy message. In step 252 the PCF 126, checks the operator policy for the PLMN and determines that N3GPP path switching feature is supported and allowed by the PLMN and generates and sends ATSSS policy message 254 communicating that N3GPP path switching is allowed to SMF 124. In step 256 the SMF 124 receives message 254 and recovers the communicated information. In step 256, the SMF 124 derives ATSSS rules, based on the received ATSSS policy message 254 including information indicating that N3GPP path switching is supported for N3GPP access network, thus the N3GPP path switching capability will be included as part of the ATSSS rules. The ATSSS rules including the information the N3GPP path switching is supported will be subsequently sent back to the UE 102. In step 260 the SMF 124 generates and sends N4: session establishment message 262 including ATSSS CN tunnel information for N3GPP network #A and N4 rules including the N3GPP path switching support capability, to UPF 128. In step 264, the UPF 128 receives the session establishment request message 262 and recovers the communicated information including ATSSS CN tunnel information for N3GPP network #A and N4 rules. In step 265 the UPF performs ATSSS related functions including generating a link specific address, address #1, for this path and corresponding N3 tunnel information. In step 266, the UPF generates and sends N4: session response message 268 including an ATSSS link specific address, which is address #1, to the SMF 124. In step 270, the SMF 124 receives PDU session establishment accepted message 268 and recovers the communicated information including the ATSSS link specific address, address #1.

In step 272 the SMF 124 generates and sends MA PDU accepted message 274 including ATSSS rules, including an indication that N3GPP path switching supported, and the link specific address, which is address #1 to AMF 122. In step 276, the AMF 122 receives the MA PDU accepted message 274 and recovers the communicated information indicating that N3GPP path switching is supported and link specific address #1. In step 278, the AMF 122 generates and sends, via N3GPP access network #A, a PDU session establishment accept message 280 including ATSSS rules (including information indicating N3GPP path switching supported) and link specific address #1. In step 282 the UE 102 receives the PDU session establishment message 280 and recovers the communicated information including the ATSSS rules including information indicating N3PPP path switching is supported, and the link specific address #1 to be used for communicating via path #1 using N3GPP access network #A 106.

In steps 284 and 286, the UE 102 and N3GPP access network #A 106 are operated to establish the user plane over network #A via path #1. In steps 290 and 292 the N3GPP access network #A 106 and the ATSSS function of the UPF 128 are operated to establish the user plane over N3GPP network #A (path 1) from the N3GPP access network #A 106 to the UPF 128. In steps 296 and 298 the ATSSS function of the UPF 128 and the data network 130 are operated to establish a user plane path portion via N6 connection 300.

Block 301 indicates that the operations and signaling of FIG. 2B is a continuation from the operations and signaling of FIG. 2A.

In step 302, the UE 102, e.g., due to mobility, discovers a new N3GPP access network, which is N3GPP access network #B 108, e.g., a second WiFi network. Operation proceeds from step 302 to step 304.

In step 304, the UE performs 5G registration to the PLMN and uses the 5G-GUTI received in step 214. Thus, in step 304, the UE 102 generates and sends, via N3GPP access #B, a registration message 306 including its 5G-GUTI (which was previously assigned to the UE 102 by the AMF 122) to AMF 122 of PLMN 156. In step 308 the AMF 122 receives the 5G registration message 306 including the 5G-GUTI, and in response, in step 310 the AMF 122 generates and sends, via the N3GPP access #B, a 5G registration accept message 317 to the UE 102. In step 314 UE 102 receives the 5G registration accept message 212.

In step 316, in response to the received registration accept message 312, the UE 102 generates and sends, via N3GPP access #B, a request for a multi-access (MA) protocol data unit (PDU) session to the AMF 122, to request a MA PDU session. As part of generating the request, the UE 102 includes the same session ID, which is ID#A. Thus, in step 316, the UE 102 sends, via N3GPP access network #B 108, 5G PDU session request message 318 including a MA PDU request and PDU session ID#A to AMF 122.

In step 318 AMF 122 receives session establishment request message 318 and recovers the communicated information. In step 319 the AMF 122 determines that the PDU session establishment request is for a session for which a user data plane path already exists. The AMF 122 has recognized that the received session ID communicated in the request, which is ID#A, is already in use, and therefore, determines that a switch is to be indicated. The same PDU session ID (ID#A) and the MA PDU session request triggers the same AMF 122 to indicate to SMF with a path switching indication which indicates that this new N3GPP path (path #2) is to replace the old N3GPP path (path #1) in the MA PDU session. In step 320, the AMF 122 generates and sends NSFM: create SM Context message including MA PDU session ID#A, and a N3GPP switch indication, to SMF 324. In step 324 the SMF 124 receives create SM context message 324, and in response, in step 326 the SMF 124 generates and sends NSMF: normal SM response message 328 to AMF 122, which is received by the AMF 122 in step 330.

In step 332 the SMF 124 generates and sends check operator policy message 334 to PCF 126 to check for additional ATSSS policy if any. In step 336 the SMF receives the check policy message. In step 338 the PCF 126 generates and sends ATSSS policy message 340, e.g., communicating any additional ATSSS policies to SMF 124. In step 342 the SMF 124 receives ATSSS policy message 340 and recovers the communicated information. In step 344, the SMF 124 derives new ATSS rules if needed. In step 346 the SMF 124 generates and sends N4: session establishment message 348 including ATSSS N3 CN tunnel information for N3GPP network #B, switch indication, and N4 rules to UPF 128. In step 350, the UPF 128 receives the session establishment request message 348 and recovers the communicated information including ATSSS CN tunnel information for N3GPP network#B, switch indication, and N4 rules. In step 351 the UPF 128 performs ATSSS related functions including: generating an ATSSS link specific address, which is address #2, for this path (path #2), generating corresponding N3 tunnel information (for path #2), and indicates that this new N3 tunnel (for path #2) replaces the other N3 tunnel (i.e., for path #1). In step 352, the UPF 128 generates and sends N4: session response message 354 including the generated ATSSS link specific address, which is address #2, to the SMF 124. In step 356, the SMF 124 receives message 354 and recovers the communicated information. In step 357 the UPF 128 and its ATSSS function, is operated so that the ATSSS downlink (DL) traffic (for UE 102) uses the N3 tunnel for network #B.

In step 358 the SMF 124 generates and sends MA PDU accepted message 360 including ATSSS rules (N3GPP path switching supported), and link specific address #2 to AMF 122. In step 362, the AMF 122 receives the PDU accepted message 360 and recovers the communicated information indicating that N3GPP path switching is supported and link specific address #2. In step 364, the AMF 122 generates and sends, via N3GPP access network #B 108, a PDU session establishment accept message 366 including ATSSS rules (including information indicating N3GPP path switching supported) and link specific address #2. In step 368 the UE 102 receives the PDU session establishment message 366 and recovers the communicated information including the ATSSS rules including information indicating that N3GPP path switching is allowed and the link specific address #2 to be used for communicating via path #2 using N3GPP access network #B 108.

In steps 368 and 372, the UE 102 and N3GPP access network #B 108 are operated to establish the user plane over network #B via path #2. In steps 376 and 378 the N3GPP access network #B 108 and the ATSSS function of the UPF 128 are operated to establish the user plane over N3GPP network #B (path 2) from the N3GPP access network #B 108 to the UPF 128. In steps 382 and 384 the ATSSS function of the UPF 128 and the data network 130 are operated to establish a user plane path portion via N6 connection 386. In step 387 the UE 102 uses this new established PDU session (corresponding to N3GPP access network #B 108 and path #2 with the N3 tunnel for network #B) for data path transmission in the MA PDU session, e.g., for ATSSS MA PDU traffic.

Block 303 indicates that the operations and signaling of FIG. 2C is a continuation from the operations and signaling of FIG. 2B.

In step 388 the UE 102 initiates a de-registration for path #1. In step 390 the UE 102 generates and sends, e.g., via N3GPP access network #B 108, a 5G de-registration message 392 to AMF 122 (which is the same AMF for path#1 and path #2), requesting de-registration with regard to N3GPP access network #A, said message including the 5G-GUTI, N3GPP access indication. The AMF 122 is aware of which N3GPP N3 tunnel is inactive due to the switching, which occurred in FIG. 2B. In step 394 the AMF 122 receives the de-registration request message 392. In step 396 the AMF 122 generates and sends NSFM: Release SM Context message (including an N3GPP access indication) 398 to SMF 124. In step 400 the SMF 124 receives the release context message 398, and in response in step 402 the SMF 124 is operated to indicate to the UPF 128 to release the N3 CN tunnel for N3GPP network #A. The SMF 124 was also aware of which tunnel was inactive due to the switching of FIG. 2B. Thus, in step 404, the SMF generates and sends N4: session release message 406 to UPF 128 indicating release N3 CN tunnel for N3GPP network #A. In step 408 the UPF 128 receives the session release message 406, and in response, in step 410 the UPF 128 generates and sends N4: session release acknowledgment message 412 to SMF 124. In step 414 the SMF 124 receives the session release ack 412.

In step 416 the SMF 124 generates and sends NSMF: normal release SM response message 418 to AMF 122, which is received by the AMF 122 in step 420.

In step 422 the AMF 122 generates and sends N2 UE context release message 424 to N3GPP access network #A. In step 426 the N3GPP access network #A receives the UE context release message and release resources related to UE 102 and path#1.

In step 428 the AMF 122 generates and sends a 5G de-registration accept message 430 to UE 102, via N3GPP network #B 108. In step 432 the UE 102 receives the de-registration accept message 430, and in response in step 434, the UE locally releases any resources associated with path #1.

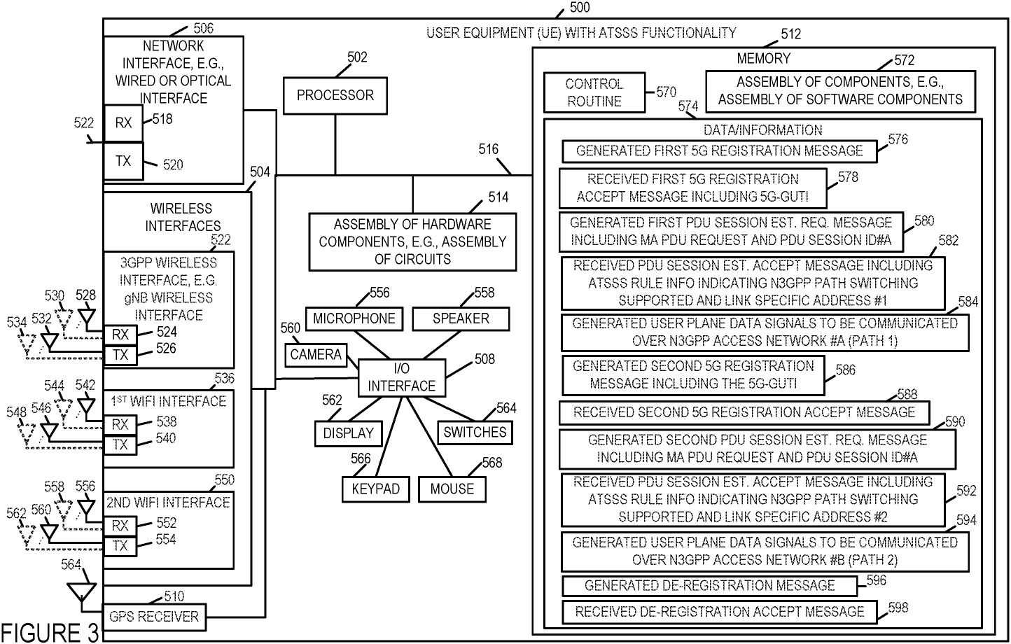

FIG. 3 is a drawing of an exemplary user equipment (UE) 500 with ATSSS functionality in accordance with an exemplary embodiment. UE 500 is, e.g., UE 102 of system 100 of FIG. 1. UE 500 includes a processor 502, e.g., a CPU, wireless interfaces 504, a network interface 506, an I/O interface 508, a GPS receiver 510, memory 512, an assembly of hardware components 514, e.g., an assembly of circuits, coupled together via a bus 516. UE 500 further includes a plurality of I/O devices (microphone 556, speaker 558, camera 560, display 562, e.g., a touch screen display, switches 564, keypad 566, mouse 568) coupled to I/O interface 508, which couples the I/O devices to bus 516 and other components within UE 500.

Wireless interfaces 504 includes a 3GPP wireless interface 522, e.g., a gNB wireless interface, a 1st WiFi interface 536 and a 2nd WiFi interface 550. 3GPP wireless interface 522 includes wireless receiver 524 coupled to one or more receive antennas (528, ..., 530), via which the UE 500 receives cellular signals, e.g., from a gNB base station. 3GPP wireless interface 522 further includes wireless transmitter 526 coupled to one or more transmitter antennas (532, ..., 534), via which the UE 500 transmits cellular signals, e.g., to a gNB base station. 1st WiFi interface 536 includes wireless receiver 538 coupled to one or more receive antennas (542, ..., 544), via which the UE 500 receives WiFi signals, e.g., from a first N3GPP access point. 1st WiFi wireless interface 536 further includes wireless transmitter 540 coupled to one or more transmitter antennas (546, ..., 548), via which the UE 500 transmits WiFi signals, e.g., to a first N3GPP AP. 2nd WiFi interface 550 includes wireless receiver 552 coupled to one or more receive antennas (556, ..., 558), via which the UE 500 receives WiFi signals, e.g., from a second N3GPP access point. 2nd WiFi wireless interface 550 further includes wireless transmitter 554 coupled to one or more transmitter antennas (560, ..., 562), via which the UE 500 transmits WiFi signals, e.g., to a second N3GPP AP. In some embodiments, the same antenna or antennas are used for both transmit and receive, e.g., in a time duplex division embodiment. In some embodiments, the same WiFi interface is used for communicating with multiple WiFi APs. In some embodiments, different WiFi interfaces correspond to different frequency bands.

Network interface 506, e.g., a wired or optical interface, includes a receiver 518 and a transmitter 520 coupled to connector 522 which may, and sometimes does, couple the UE 500 to other network nodes and/or the Internet via a wired or optical connection, e.g., when the UE 500 is at a location where a wired or optical connection is available.

Memory 512 includes a control routine 570, e.g., for controlling the UE 500 to implement basis functions, e.g., memory access operations, I/O device control, receiver control, etc., and an assembly of components 572, e.g., an assembly of software components. Assembly of components includes, e.g., routines, subroutines, software modules, and/or applications, which when executed by the processor 502 control the UE 500 to implement steps of an exemplary method, e.g., steps of the exemplary communications method of FIG. 2, which are performed by the UE 102.

Data/information 574 includes a generated first 5G registration message 576, a received first 5G registration accept message 578 including a 5G-GUTI, a generated first PDU session establishment request message 580 including a MA PDU request and a PDU session ID, e.g., ID #A, a received PDU session establishment accept message 582 including ATSSS rule information indicating that N3GPP path switching is supported and a link specific address, e.g. address #1, and generated user plane data signals 584 to be communicated over the first N3GPP access network (N3GPPP access network A) (path 1).

Data/information 574 further includes a generated second 5G registration message 586 including the 5G-GUTI received in message 578, a received second 5G registration accept message 588, a generated second PDU session establishment request message 590 including a MA PDU request and the PDU session ID (previously assigned which corresponds to the ongoing session), e.g., ID #A, a received PDU session establishment accept message 592 including ATSSS rule information indicating that N3GPP path switching is supported and a new link specific address, e.g. address #2, and generated user plane data signals 594 to be communicated over the second N3GPP access network (N3GPPP access network B) (path 2).

Data/information 574 further includes a generated de-registration request message 596, e.g., for initiating de-registration with regard to the first N3GPP access network (network A), and a received de-registration accept message 598.

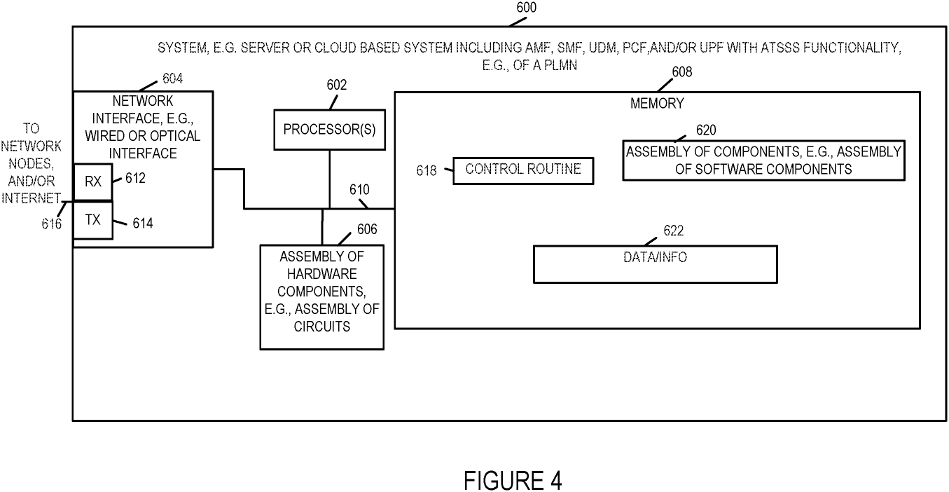

FIG. 4 is a drawing of an exemplary system 600, e.g., a server or cloud network including an interface and one or more processors which provide AMF, SMF, UDM, PCF and/or UPF with ATSSS functionality, or a data network (DN) server, in accordance with an exemplary embodiment. Exemplary system 600 includes a processor 602, e.g., a CPU, a network interface 604, e.g., a wired or optical interface, an assembly of hardware components 606, e.g., an assembly of circuits, and memory 608 coupled together via a bus 610 over which the various elements interchange data and information.

Network interface 604 includes a receiver 612 and a transmitter 614 coupled to connector 616, which couples the server 600 to other network nodes, e.g., other servers, core network devices, routers, etc. and/or the Internet. Memory 608 includes a control routine 618 and an assembly of components 620, e.g., an assembly of software components.

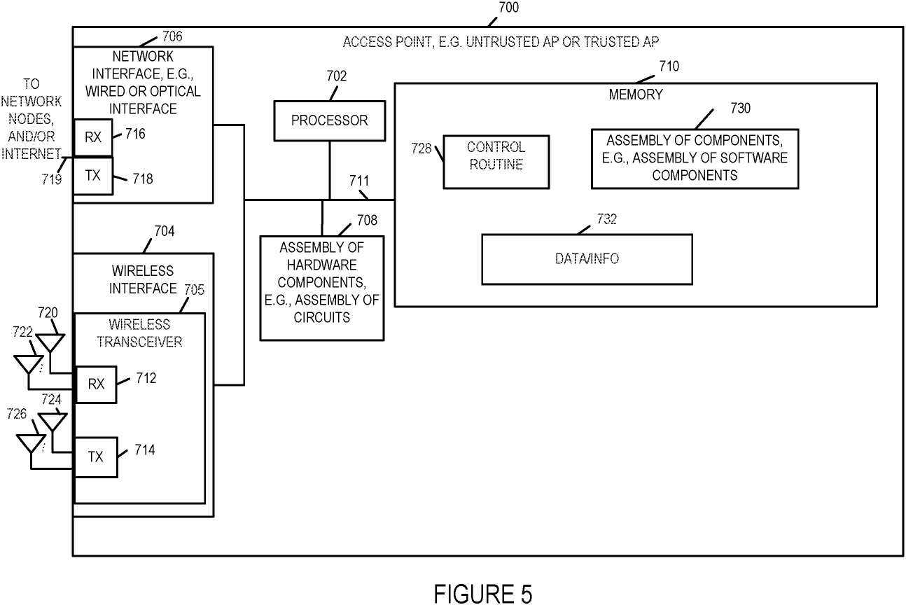

FIG. 5 is drawing of an exemplary access point (AN) 700 such as a WiFi AP, e.g., an untrusted network AP or a trusted network access point (TNAP), in accordance with an exemplary embodiment. Exemplary access point 700 includes a processor 702, e.g., a CPU, a wireless interface 704, e.g., a WiFi interface, a network interface 706, e.g., a wired or optical interface, an assembly of hardware components 708, e.g., an assembly of circuits, and memory 710 coupled together via a bus 711 over which the various elements interchange data and information.

Wireless interface 704 includes a wireless receiver 712 coupled to a plurality of receive antennas (720, ..., 722), via which the AP 700 receives WiFi signals from UEs, and a wireless transmitter 714 coupled to one or more transmit antennas (724, ..., 726), via which the AP 700 transmits WiFi signals to UEs. In some embodiments, the receiver 712 and transmitter 714 are part of a transceiver 705, e.g., a WiFi transceiver. In some embodiment one or more antennas are used for both receive and transmit, e.g., in a TDD embodiment.

Network interface 706 includes a receiver 716 and a transmitter 718 coupled to connector 719, which couples the access point 700 to other network nodes, e.g., other APs, base stations, various servers or devices including an AMF, SMF, UDM, PCF and/or UPF with ATSSS functionality, a data network (DN) server, various core network devices, routers, etc. and/or the Internet. Memory 710 includes a control routine 728 and an assembly of components 730, e.g., an assembly of software components.

Various aspects and/or features of some embodiments of the present invention are described below. Refer to FIGS. 2A, 2B and 2C.

The following sets forth an exemplary numbered sequence of grouped operations, messages and/or procedures:

1. The UE (102) discovers N3GPP access # A (106) (e.g., first WiFi network.) (See step 202.)

2. UE (102) performs 5G registration to the PLMN and receives 5G-GUTI from AMF (122). (See step 204, message 206, step 208, step 210, message 212 and step 214.)

3. UE (102) requests MA PDU session. (See step 216, message 218 and step 220). The UE (102) generates a PDU session ID (ID#A) (See step 215). AMF (122) requests SMF (to create the MA PDU session. (See step 222, message 224 and step 226.) SMF (124) checks subscription to ensure MA PDU session is allowed. (See step 228, message 230, step 232, step 234, message 236, and step 238).

4. SMF (124) checks PCF (126) for additional ATSSS policy if any (See steps 246, message 248, step 250, step 252, message 254 and step 256).

5. Since this PLMN supports N3GPP path switching feature, SMF (124) will allow this capability (e.g., as part of ATSSS rules) which will be sent back to UE (102). (See step 258.)

6. SMF (124) indicates to UPF (128) to perform ATSSS related function (e.g., generates link specific address #1 for this path and corresponding tunnel information). (See step 260, message 262, step 264, step 265, step 266, message 268 and step 270.)

7. UE (102) receives MA PDU session adapted message with the link specific address #1 for this path along with ATSSS rules and the indication that the N3GPP path switching feature is supported. (See step 272, message 274, step 276, stepe 278, message 280 and step 282.)

8. Due to mobility, the UE (102) discovers a new N3GPPP access #B (108) (e.g., another WiFi network). (See step 302.)

9. UE (102) performs 5G registration to the PLMN and uses the 5G-GUTI received in step 214. (See step 304, message 306, step 308, stepe 310, message 312 and step 314.)

10. UE (102) requests MA PDU session. (See step 316, message 317, and step 318.) The UE (102) reuses the PDU session ID (ID#A) from steps (215, 216). The same PDU session ID (ID#A) and MA PDU session request triggers the same AMF (122) to indicate to SMF (124) with a N3GPP path switching indication which indicates that this new N3GPP path (#2) is to replace the old N3GPP path (#1) in the MA PDU session. (See steps 319, 320, message 322, step 324, step 326, message 328 and step 330.)

11. SMF (124) checks PCF (126) for additional ATSSS policy if any. (See step 332, message 334, step 336, step 338, message 340 and step 342.)

12. SMF (124) may generate new ATSSS rules is needed (See step 344).

13. SMF (124) indicates to the UPF (128) to perform ATSSS related function(s) (e.g., generates link specific address#2 for this path and corresponding N3 tunnel information, and indicates that this new N3 tunnel replaces the other N3 tunnel (i.e., for path #1)). (See step 346, message 348, step 350, step 351, step 352, message 354, step 356, and step 357.)

14. UE (102) receives MA PDU session accepted message with the link specific address #2 for this path#2. (See step 358, message 360, step 362, step 364, message 366, and step 368.)

15. UE (102) uses this new established path (#2) for data path transmission in the MA PDU session. (See steps, 370, 372, 376, 378, 382, 384, and 387, and path portions 374, 386, 380).

After the UE (102) has switched the MA PDU session to path#2 from path#1, the UE (102) may release the N1 connection associated with path#1 by performing 5G deregistration procedure with AMF (122) or AMF (122) may perform network initiated deregistration when MA PDU session has been established over path #2 and UE has not initiated the deregistration procedure after some waiting period.

The UE (102) releases the resources associated with path#1 by performing 5G deregistration procedure. The UE (102) initiates a 5G deregistration procedure to clean up resources associated with path #1.

16. After path switching from path#1 to path #2, UE (102) initiates 5G deregistration procedure to clean up the resources associated with path #1.

17. The UE (102) sends 5G de-registration message to AMF (122) with 5G-GUTI and N3GPP Access indication. (See steps 390, message 392, step 394.) 5G-GUTI points to the same AMF (122) used for path #1 and path #2. N3GPP access indication allows the SMF (124) to clear any resources associated with the non-active N3GPP N3 tunnel (i.e., used for path #1) with the UPF (128). (See step 396, message 398, steps 400, 402, 404, message 406, step 408, step 410, message 412 and step 412.) SMF (124) and AMF (122) aware of which N3GPP N3 tunnel is inactive due to the switching procedure shown in FIG. 2B. AMF (122) cleans up the resources in the N3GPP access network #A by sending N2 UE context release message. (See step 422, message 424, step 426.)

18. UE (102) locally releases any resources associated with path #1 when de-registration accept message is received. (See step 428, message 430, step 432 and step 434.)

For network initiated clean up procedure, AMF (122) starts in 392 in FIG. 2C without waiting for the UE (102) to send the 4G de-registration message 392 in step 390. The rest of the steps follow to clear the resources used for path#1.

References to previous numbered embodiments in the following lists refer to the same group or list in which the reference is made. For example, in the second numbered list of exemplary method embodiments the reference to “Method Embodiment 1”, in Method Embodiment 2, refers to Method Embodiment 2 in the second list of numbered method embodiments.

### First Numbered List of Exemplary Method Embodiments

Method Embodiment 1. A communications method, the method comprising: receiving (220), at an Access and Mobility Management Function (AMF) (122), a first Protocol Data Unit (PDU) session (e.g., 5G PDU session) establishment request (218) from a User Equipment (UE) (102) communicated via a first non-3GPP access network (106), said first PDU session establishment request (218) including a first PDU session ID number (ID#A); and sending (278) from the AMF (122) to the UE (102), via the first non-3GPP access network (106), first PDU session establishment information (included in PDU session establishment accept message (280)) including a first link specific address (e.g., address #1) to be used by the UE for communication via the first N3GPP network (106) for the first PDU session identified by the first PDU session ID number (ID#A) and Access Traffic Steering Switching and Splitting (ATSSS) information indicating that N3GPP path switching is supported (e.g., for the first PDU session conducted via the first N3GPP access network (106)).

Method Embodiment 2. The method of Method Embodiment 1, further comprising: receiving (318) at the AMF (122) a second PDU session establishment request (317) from the UE (102) communicated via a second non-3GPP access network (108), said second PDU session establishment request (317) including the first PDU session ID number (ID #A).

Method Embodiment 2A. The method of Method Embodiment 2, further comprising: determining (319), at the AMF (122) (which is the same AMF that handled the initial registration message), that the second PDU session establishment request (317) is for a session for which a user plane data path already exists (e.g., the AMF is the same AMF used to establish the user plan data path (N3 3GPP path); and sending, (320) from the AMF (122) to a SMF (124) a path switch message (322) ( referred to as create SM context message) including the first session ID (ID#A) and indicating that that a second (e.g., new) user plane data path (path #2) is to replace the existing user plane data path (path#1) for the first session.

Method Embodiment 2C. The method of Method Embodiment 2A, wherein the first user plane data path is via the first N3GPP access network (e.g., a first WiFi access network, N3GPP access network #A) and wherein the second user plane data path is via the second N3GPP access network (e.g., a second WiFi access network, N3GPP access network #B).

Method Embodiment 2D. The method of Method Embodiment 2A, further comprising: operating the SMF (124) to send (346) a message (348) to a UPF (128) indicating to the UPF (128) that it should implement an ATSSS function relating to the first session.(e.g., a session establishment message with ATSSS N3 CN tunnel information for an N3 tunnel to be created for the second N3GPP access network (network B)).

Method Embodiment 2E1. The method of Method Embodiment 2D, wherein said message (348) to the UPF (128) indicates that a second tunnel via the second N3GPP access network should be used to replace a first tunnel via the first N3GPP access network for the user plane of the first session (e.g., the session identified by session ID A which is included in the message (348) sent to the UPF (128)

Method Embodiment 2E2. The method of Method Embodiment 2D, operating the UPF (128), as part of implementing the ATSSS function in response to the message (session establishment message 348) from the SMF (124), to: generate (351) a second link specific address (address #2) for the second user plane data path; and send (352) a session establishment response to the SMF (124) providing the second link specific address to be used for said first session (the session identified by session ID A) when communicating via the second N3GPP access network (N3GPP Access #B).

Method Embodiment 2D1. The method of Method Embodiment 2A, further comprising: sending (364) from the AMF (122) to the UE (102), via the second non-3GPP access network (108), second PDU session establishment information (included in PDU session establishment accept message (366)) including a second link specific address (e.g., address #2 to be used by the UE for the established first PDU session corresponding to the first session ID (ID#A) where address #2 is different from address #1) and Access Traffic Steering Switching and Splitting (ATSSS) information indicating that N3GPP path switching is supported (e.g., for the established first PDU session which is conducted via the second N3GPP access network N3GPP access network # B).

Method Embodiment 3. The method of Method Embodiment 2, further comprising: sending (422), from the AMF (122) to the first N3GPP access network (106) a context release message (424) instructing the first N3GPP access network to release resources at the first N3GPP access network which were used to support the first PDU session corresponding to said PDU session ID number.

Method Embodiment 4. The method of Method Embodiment 3, further comprising: receiving (420) at the AMF 122, prior to sending said context release message (424), a release response message (418) (e.g. from the session management function (SMF)) corresponding to the first PDU session conducted via the first NG3PP access network (106) after successful establishment of a PDU data plane via the second N3GPP access network (108) for the session identified by said first PDU session ID number (ID#A).

Method Embodiment 5. The method of Method Embodiment, further comprising: receiving (394) at the AMF (122) a deregistration request (392) from the UE (102), (e.g. communicated via in some cases the second N3GPP access network (108) but which in other cases is communicated via the first N3GPP access network) requesting deregistration of a registration with the first N3GPP access network; and wherein said context release message (424) instructing the first N3GPP access network to release resources at the first N3GPP access network which were used to support the first PDU session corresponding to said PDU session ID number (ID#A) is sent from the AMF (122) after receipt of said deregistration request.

Method Embodiment 6. The method of Method Embodiment 5, further comprising: sending (428) to the UE (102) from the AMF (122) via the second access network (108) a 5G de-registration accept message (430) indicating acceptance of the de-registration request relating to the UE registration corresponding to the first N3GPP access network (106).

### First Numbered List of Exemplary System Embodiments

System Embodiment 1. A communications system (100), the system (100) comprising: an Access and Mobility Function (AMF) (122 or 600) comprising: a first receiver (612); a first transmitter (614); and a first processor (602) configured to operate the AMF (122) to: receive (220), (via receiver 612) at an Access and Mobility Management Function (AMF) (122), a first Protocol Data Unit (PDU) session (e.g., 5G PDU session) establishment request (218) from a User Equipment (UE) (102) communicated via a first non-3GPP access network (106), said first PDU session establishment request (218) including a first PDU session ID number (ID#A); and send (278) (via transmitter 614) to the UE (102), via the first non-3GPP access network (106), first PDU session establishment information (included in PDU session establishment accept message (280)) including a first link specific address (e.g., address #1) to be used by the UE for communication via the first N3GPP network (106) for the first PDU session identified by the first PDU session ID number (ID#A) and Access Traffic Steering Switching and Splitting (ATSSS) information indicating that N3GPP path switching is supported (e.g., for the first PDU session conducted via the first N3GPP access network (106)).

System Embodiment 2. The communication system (100) of claim 1, wherein said first processor (602) is further configured to: operate the AMF (122) to receive (318) (via receiver 612) a second PDU session establishment request (317) from the UE (102) communicated via a second non-3GPP access network (108), said second PDU session establishment request (317) including the first PDU session ID number (ID #A).

System Embodiment 2A. The communications system (100) of claim 2, wherein said first processor (602) is further configured to: determine (319), at the AMF (122) (which is the same AMF that handled the initial registration message), that the second PDU session establishment request (317) is for a session for which a user plane data path already exists (e.g., the AMF is the same AMF used to establish the user plan data path (N3 3GPP path); and operate the AMF (122) to send (via transmitter 614) to a SMF (124) a path switch message (322) ( referred to as create SM context message) including the first session ID (ID#A) and indicating that that a second (e.g., new) user plane data path (path #2) is to replace the existing user plane data path (path#1) for the first session.

System Embodiment 2C. The communications system (100) of claim 2A, wherein the first user plane data path is via the first N3GPP access network (e.g., a first WiFi access network, N3GPP access network #A) and wherein the second user plane data path is via the second N3GPP access network (e.g., a second WiFi access network, N3GPP access network #B).

System Embodiment 2D. The communications system (100) of claim 2A, further comprising: said SMF (124 or 600′) including: a second transmitter (614′); and a second processor (602′) configured to: operate the SMF (124) to send (346) a message (348) to a user plane function (UPF) (128) indicating to the UPF (128) that it should implement an ATSSS function relating to the first session (e.g., a session establishment message with ATSS N3 CN tunnel information for an N3 tunnel to be created for the second N3GPP access network (network B)).

System Embodiment 2E1. The communications system (100) of claim 2D, wherein said message (348) to the UPF (128) indicates that a second tunnel via the second N3GPP access network should be used to replace a first tunnel via the first N3GPP access network for the user plane of the first session (e.g., the session identified by session ID A which is included in the message (348) sent to the UPF (128).

System Embodiment 2E2. The communications system (100) of claim 2D, further comprising: said UPF (128 or 600″) including a third transmitter (614″) and a third processor (602″) configured to: operate the UPF (128), as part of implementing the ATSSS function in response to the message (session establishment message 348) from the SMF (124), to: generate (351) a second link specific address (address #2) for the second user plane data path; and send (352) (via TX 614″) a session establishment response to the SMF (124) providing the second link specific address to be used for said first session (the session identified by session ID A) when communicating via the second N3GPP access network (N3GPP Access #B).

System Embodiment 2D1. The communications system (100) of claim 2A, wherein said first processor (602) is further configured to: operate the UE to send (364) (via TX 614) from the AMF (122) to the UE (102), via the second non-3GPP access network (108), second PDU session establishment information (included in PDU session establishment accept message (366)) including a second link specific address (e.g., address #2 to be used by the UE for the established first PDU session corresponding to the first session ID (ID#A) where address #2 is different from address #1) and Access Traffic Steering Switching and Splitting (ATSSS) information indicating that N3GPP path switching is supported (e.g., for the established first PDU session which is conducted via the second N3GPP access network N3GPP access network # B).

System Embodiment 3. The communications system (100) of claim 2, wherein said first processor (602) is further configured to: operate the AMF (122) to send (422) (via TX 614), from the AMF (122) to the first N3GPP access network (106) a context release message (424) instructing the first N3GPP access network to release resources at the first N3GPP access network which were used to support the first PDU session corresponding to said PDU session ID number.

System Embodiment 4. The communications system (100) of claim 3, wherein said first processor (602) is further configured to operate the AMF (122) to: receive (420) at the AMF 122 (via RX 612), prior to sending said context release message (424), a release response message (418) (e.g. from the session management function (SMF)) corresponding to the first PDU session conducted via the first NG3PP access network (106) after successful establishment of a PDU data plane via the second N3GPP access network (108) for the session identified by said first PDU session ID number (ID#A).

System Embodiment 5. The communications system (100) of claim 4, wherein said first processor (602) is further configured to: operate the AMF (122) to receive (394) (via RX 612) at the AMF (122) a deregistration request (392) from the UE (102), (e.g. communicated via in some cases the second N3GPP access network (108) but which in other cases is communicated via the first N3GPP access network) requesting deregistration of a registration with the first N3GPP access network; and wherein said context release message (424) instructing the first N3GPP access network to release resources at the first N3GPP access network which were used to support the first PDU session corresponding to said PDU session ID number (ID#A) is sent from the AMF (122) after receipt of said deregistration request.

System Embodiment 6. The communications system (100) of claim 5, wherein said first processor (602) is further configured to: operate the AMF (122) to send (428) (via TX 614) to the UE (102) from the AMF (122) via the second access network (108) a 5G de-registration accept message (430) indicating acceptance of the de-registration request relating to the UE registration corresponding to the first N3GPP access network (106).

### First Numbered List of Exemplary Non-Transitory Computer Readable Medium Embodiments

1. A non-transitory computer readable medium (608) including machine executable instruction, which when executed by one or more processors (602, 602′, and/or 602″) control one or more devices (600, 600′ and/or 600″) including an AMF (122) to perform the steps of: receiving (220), at the Access and Mobility Management Function (AMF) (122), a first Protocol Data Unit (PDU) session (e.g., 5G PDU session) establishment request (218) from a User Equipment (UE) (102) communicated via a first non-3GPP access network (106), said first PDU session establishment request (218) including a first PDU session ID number (ID#A); and sending (278) from the AMF (122) to the UE (102), via the first non-3GPP access network (106), first PDU session establishment information (included in PDU session establishment accept message (280)) including a first link specific address (e.g., address #1) to be used by the UE for communication via the first N3GPP network (106) for the first PDU session identified by the first PDU session ID number (ID#A) and Access Traffic Steering Switching and Splitting (ATSSS) information indicating that N3GPP path switching is supported (e.g., for the first PDU session conducted via the first N3GPP access network (106)).

### Second Numbered List of Exemplary Method Embodiments

Method Embodiment 1. A method of operating a user device (UE) comprising: sending (204), via a first N3GPP access network (106), to an Access and Mobility Management Function (AMF) (122) of a Public Land Mobile Network (PLMN) which provides service to the UE, a first registration message (206); receiving from the AMF a registration accept message including a first Global Unique Temporary Identifier (GUTI) (e.g., 5G GUTI) assigned by the PLMN to the UE; generating, (215) at the UE, a first PDU session ID (e.g., session ID #A); sending (216) a first Protocol Data Unit (PDU) session (e.g., 5G PDU session) establishment request (218) to the AMF (122) via the first non-3GPP access network (106), said first PDU session establishment request (218) including the first PDU session ID number (ID#A) and the first GUTI; and receiving (282) from the AMF (122), first PDU session establishment information (e.g., included in PDU session establishment accept message (280)) communicated via the first non-3GPP access network (106), the first PDU session establishment information including a first link specific address (e.g., address #1) to be used by the UE for communication via the first N3GPP network (106) for the first PDU session corresponding to the first PDU session ID number (ID#A) and Access Traffic Steering Switching and Splitting (ATSSS) information indicating that N3GPP path switching is supported (e.g., for the first PDU session conducted via the first N3GPP access network (106)).

Method Embodiment 2. The method of Method Embodiment 1, further comprising: establishing (284) a first user plane data path (Path #1) for a communications session corresponding to the first session identifier (e.g., session identifier #A) via the first N3GPP access network (106).

Method Embodiment 3. The method of Method Embodiment 1, further comprising: sending (316) a second PDU session establishment request (317) to the AMF (122) via a second N3GPP access network (108), said second PDU session establishment request (317) including the first PDU session ID number (ID #A) (and in some embodiments also including the GUTI assigned to the UE thereby allowing the AMF to determine that the session corresponding to the first PDU session ID (ID #A) is an ongoing session which is to be maintained and switched to a data path of the second N3GPP access network).

Method Embodiment 4. The method of Method Embodiment 2, further comprising: receiving (368) via the second non-3GPP access network (108), from the AMF (122), second PDU session establishment information (included in PDU session establishment accept message (366)) including a second link specific address (e.g., address #2 to be used by the UE for the established second PDU session corresponding to the first session ID (ID#A) for communicating via the second N3GPP access network (access network #B), where address #2 is different from address #1) and Access Traffic Steering Switching and Splitting (ATSSS) information indicating that N3GPP path switching is supported (e.g., for the established first PDU session which is conducted via the second N3GPP access network (N3GPP access network # B)).

Method Embodiment 5. The method of Method Embodiment 3, further comprising: establishing (370) a second user plane data path (Path #2) via the second N3GPP access network for the ongoing communications session corresponding to the first session ID (e.g., session ID A).

Method Embodiment 6. The method of Method Embodiment 5, further comprising: deciding (388), following establishment of the second user plane data path via the second N3GPP access network to initiate de-registration with regard to the first traffic data path established through the first N3GPP access network following receipt of the second PDU session establishment information and establishment of the second user plane data path; and sending (390) a de-registration message to the AMF (122) to initiate deregistration with respect to the first N3GPP access network (e.g., WiFi network #A).

Method Embodiment 7. The method of Method Embodiment 6, further comprising: receiving (432) from the AMF (122), via the second N3GPP access network (108), a 5G de-registration accept message (430) indicating acceptance of the de-registration request relating to the UE registration corresponding to the first N3GPP access network (106).

### First Numbered List of Exemplary Apparatus Embodiments

Apparatus Embodiment 1. A user device (UE) (102 or 500) comprising: at least one wireless receiver (RX 538); at least one wireless transmitter (TX 540); and a processor (502) configured to: operate the UE to send (204) (e.g., via 1st WiFi wireless transmitter 540), via a first N3GPP access network (106), to an Access and Mobility Management Function (AMF) (122) of a Public Land Mobile Network (PLMN) (156) which provides service to the UE, a first registration message (206); operate the UE to receive (214) (e.g., via 1st WiFi wireless receiver 538) from the AMF (122) a registration accept message including a first Global Unique Temporary Identifier (GUTI) (e.g., 5G GUTI) assigned by the PLMN to the UE; generate, (215) at the UE, a first PDU session ID (e.g., session ID #A); operate the UE to send (216) (e.g., via 1st WiFi wireless transmitter 540) a first Protocol Data Unit (PDU) session (e.g., 5G PDU session) establishment request (218) to the AMF (122) via the first non-3GPP access network (106), said first PDU session establishment request (218) including the first PDU session ID number (ID#A) and the first GUTI; and operate the UE to receive (282) (e.g., via 1st WiFi wireless receiver 538) from the AMF (122), first PDU session establishment information (e.g., included in PDU session establishment accept message (280)) communicated via the first non-3GPP access network (106), the first PDU session establishment information including a first link specific address (e.g., address #1) to be used by the UE for communication via the first N3GPP network (106) for the first PDU session corresponding to the first PDU session ID number (ID#A) and Access Traffic Steering Switching and Splitting (ATSSS) information indicating that N3GPP path switching is supported (e.g., for the first PDU session conducted via the first N3GPP access network (106)).

Apparatus Embodiment 2. The UE (102 or 500) of Apparatus Embodiment 1, wherein said processor (502) is further configured to: operate the UE to establish (284) a first user plane data path (Path #1) for a communications session corresponding to the first session identifier (e.g., session identifier #A) via the first N3GPP access network (106).

Apparatus Embodiment 3. The UE (102 or 500) of Apparatus Embodiment 1, wherein said processor (502) is further configured to: operate the UE to send (316) (e.g., via 2nd WiFi transmitter 554) a second PDU session establishment request (317) to the AMF (122) via a second N3GPP access network (108), said second PDU session establishment request (317) including the first PDU session ID number (ID #A) (and in some embodiments also including the GUTI assigned to the UE thereby allowing the AMF to determine that the session corresponding to the first PDU session ID (ID #A) is an ongoing session which is to be maintained and switched to a data path of the second N3GPP access network).

Apparatus Embodiment 4. The UE (102 or 500) of Apparatus Embodiment 2, wherein said processor (502) is further configured to: operate the UE to receive (368) (e.g., via 2nd WiFi wireless receiver 552), from the AMF (122), via the second non-3GPP access network (108) second PDU session establishment information (included in PDU session establishment accept message (366)) including a second link specific address (e.g., address #2 to be used by the UE for the established second PDU session corresponding to the first session ID (ID#A) for communicating via the second N3GPP access network (access network #B), where address #2 is different from address #1) and Access Traffic Steering Switching and Splitting (ATSSS) information indicating that N3GPP path switching is supported (e.g., for the established first PDU session which is conducted via the second N3GPP access network (N3GPP access network # B)).

Apparatus Embodiment 5. The UE (102 or 500) of Apparatus Embodiment 3, wherein said processor (502) is further configured to: operate the UE to establish (370) a second user plane data path (Path #2) via the second N3GPP access network for the ongoing communications session corresponding to the first session ID (e.g., session ID A).

Apparatus Embodiment 6. The UE (102 or 500) of Apparatus Embodiment 5, wherein said processor is further configured to: decide (388), following establishment of the second user plane data path via the second N3GPP access network to initiate de-registration with regard to the first traffic data path established through the first N3GPP access network following receipt of the second PDU session establishment information and establishment of the second user plane data path; and operate the UE to send (390) (e.g., via 2nd WiFi wireless transmitter 554 or the 1st WiFi wireless transmitter 540) a de-registration message to the AMF (122) to initiate deregistration with respect to the first N3GPP access network (e.g., WiFi network #A).

Apparatus Embodiment 7. The UE (102 or 500) of Apparatus Embodiment 6, wherein said processor (502) is further configured to: operate the UE to receive (432) (via the 2nd WiFi wireless receiver 552) from the AMF (122), via the second N3GPP access network (108), a 5G de-registration accept message (430) indicating acceptance of the de-registration request relating to the UE registration corresponding to the first N3GPP access network (106).

### Second Numbered List of Exemplary Non-Transitory Computer Readable Medium Embodiments

Non-Transitory Computer Readable Medium Embodiment 1. A non-transitory computer readable medium (512) including machine executable instructions, which when executed by a processor (502) of a user equipment (102 or 500) control the UE to perform the steps of: sending (204), via a first N3GPP access network (106), to an Access and Mobility Management Function (AMF) (122) of a Public Land Mobile Network (PLMN) which provides service to the UE, a first registration message (206); receiving (214) from the AMF a registration accept message including a first Global Unique Temporary Identifier (GUTI) (e.g., 5G GUTI) assigned by the PLMN to the UE; generating, (215) at the UE, a first PDU session ID (e.g., session ID #A); sending (216) a first Protocol Data Unit (PDU) session (e.g., 5G PDU session) establishment request (218) to the AMF (122) via the first non-3GPP access network (106), said first PDU session establishment request (218) including the first PDU session ID number (ID#A) and the first GUTI; and receiving (282) from the AMF (122), first PDU session establishment information (e.g., included in PDU session establishment accept message (280)) communicated via the first non-3GPP access network (106), the first PDU session establishment information including a first link specific address (e.g., address #1) to be used by the UE for communication via the first N3GPP network (106) for the first PDU session corresponding to the first PDU session ID number (ID#A) and Access Traffic Steering Switching and Splitting (ATSSS) information indicating that N3GPP path switching is supported (e.g., for the first PDU session conducted via the first N3GPP access network (106)).

Various embodiments are directed to apparatus, e.g., UEs, access points, a device including a AMF, a device including a UDM, a device including a SMF, a device including a PCF, a device including a UPF, a server, a device including a N3IWF, a device including a TNGF, base stations, e.g. sector base stations, such as gNB, ng-eNBs, eNBs, etc. supporting beamforming, UEs, base stations supporting massive MIMO such as CBSDs supporting massive MIMO, network management nodes, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, etc., other network communications devices such as routers, switches, etc., mobile network operator (MNO) base stations (macro cell base stations and small cell base stations) such as a Evolved Node B (eNB), gNB or ng-eNB, mobile virtual network operator (MVNO) base stations such as Citizens Broadband Radio Service Devices (CBSDs), network nodes, MNO and MVNO HSS devices, relay devices, e.g. mobility management entities (MMEs), an AFC system, an Access and Mobility Management Function (AMF) device, servers, customer premises equipment devices, cable systems, network nodes, gateways, cable headend and/or hubsites, network monitoring nodes and/or servers, cluster controllers, cloud nodes, production nodes, cloud services servers and/or network equipment devices. Various embodiments are also directed to methods, e.g., method of controlling and/or operating a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, UEs, a base station supporting massive MIMO such as a CBSD supporting massive MIMO, a network management node, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, network communications devices such as routers, switches, etc., user devices, base stations, e.g., eNB and CBSDs, gateways, servers (HSS server), MMEs, an AFC system, cable networks, cloud networks, nodes, servers, cloud service servers, customer premises equipment devices, controllers, network monitoring nodes and/or servers and/or cable or network equipment devices. Various embodiments are directed to communications networks which are partners, e.g., a MVNO network and a MNO network. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements are steps are implemented using hardware circuitry.

In various embodiments nodes and/or elements described herein are implemented using one or more components to perform the steps corresponding to one or more methods, for example, message reception, message generation, signal generation, signal processing, sending, comparing, determining and/or transmission steps. Thus, in some embodiments various features are implemented using components or in some embodiment’s logic such as for example logic circuits. Such components may be implemented using software, hardware or a combination of software and hardware.

Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, base stations such as NRU gNB base station, etc., a user device such as a station (STA), e.g., WiFi STA, a user equipment (UE) device, LTE LAA device, etc., an RLAN device, other network communications devices a network communications device such as router, switch, etc., a MVNO base station such as a CBRS base station, e.g., a CBSD, a device such as a cellular base station e.g., an eNB, a MNO HSS server, a MVNO HSS server, a UE device, a relay device, e.g. a MME, a AFC system, etc., said device including a processor configured to implement one, multiple or all of the steps of one or more methods of the invention.

In some embodiments, the processor or processors, e.g., CPUs, of one or more devices, e.g., a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, a UE, a base station supporting massive MIMO such as a CBSD supporting massive MIMO, a network management device, communications nodes such as e.g., access points (APs), e.g., WiFi APs, base stations such as NRU gNB base stations, etc., user devices such as stations (STAs), e.g., WiFi STAs, user equipment (UE) devices, LTE LAA devices, etc., various RLAN devices, network communications devices such as routers, switches, etc., a MVNO base station such as a CBRS base station, e.g. a CBSD, an device such as a cellular base station e.g., an eNB, a MNO HSS server, a MVNO HSS device server, a UE device, a relay device, e.g. a MME, a AFC system, are configured to perform the steps of the methods described as being performed by the communications nodes, e.g., controllers. The configuration of the processor may be achieved by using one or more components, e.g., software components, to control processor configuration and/or by including hardware in the processor, e.g., hardware components, to perform the recited steps and/or control processor configuration.

Accordingly, some but not all embodiments are directed to a device, e.g., ., a UE, an access point, a device including a AMF, a device including a UDM, a device including a SMF, a device including a PCF, a device including a UPF, a server, a device including a N3IWF, a device including a TNGF, a base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, a base station such as NRU gNB base station, etc., a user device such as station (STA), e.g., WiFi STA, a user equipment (UE) device, an LTE LAA device, etc., a RLAN device, a network communications device such as router, switch, etc., administrator device, security device, a MVNO base station such as a CBRS base station, e.g. a CBSD, an device such as a cellular base station e.g., an eNB, a MNO HSS server, a MVNO HSS device server, a UE device, a relay device, e.g. a MME, includes a component corresponding to each of one or more of the steps of the various described methods performed by the device in which the processor is included. In some but not all embodiments a device, e.g., a communications node such as UE, an access point, a device including a AMF, a device including a UDM, a device including a SMF, a device including a PCF, a device including a UPF, a server, a device including a N3IWF, a device including a TNGF, base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, a base station such as NRU gNB base station, etc., a user device such as a station (STA), e.g., WiFi STA, a user equipment (UE) device, a LTE LAA device, a RLAN device, a router, switch, etc., administrator device, security device, a AFC system, a MVNO base station such as a CBRS base station, e.g., a CBSD, a device such as a cellular base station e.g., an eNB, an MNO HSS server, a MVNO HSS device server, a UE device, a relay device, e.g. a MME, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a UE, an access point, a device including a AMF, a device including a UDM, a device including a SMF, a device including a PCF, a device including a UPF, a server, a device including a N3IWF, a device including a TNGF, a base station, e.g., a sector base station, such as gNB, ng-eNB, eNB, etc., supporting beamforming, a UE, a base station supporting massive MIMO such as a CBSD supporting massive MIMO, a network management node or device, a communications device such as a communications nodes such as e.g., a UE, an access point, a device including a AMF, a device including a UDM, a device including a SMF, a device including a PCF, a device including a UPF, a server, a device including a N3IWF, a device including a TNGF,an access point (AP), e.g., WiFi AP, a base station such as NRU gNB base station, etc., a user device such as a station (STA), e.g., WiFi STA, a user equipment (UE) device, a LTE LAA device, etc., an RLAN device, a network communications device such as router, switch, etc., administrator device, MNVO base station, e.g., a CBSD, an MNO cellular base station, e.g., an eNB or a gNB, a UE device or other device described in the present application. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

The methods and procedures used here for UE (102) and PLMN (156) can also be applied for the case where the first path #1 traverses a stand-alone Non-Public Network (SNPN) Core Network (CN), e.g., a network operated by a Non-Public Network (NPN) operator and not relying on network functions provided by a PLMN. In such a case, the SNPN CN is treated like an untrusted WiFi access points (e.g., like, N3GPP access #A 106) since the UE 102 is communicating to N3IWF 114 in the PLMN via the SNPN CN.

The methods and apparatus are well suited for use with NG3PP access networks, both trusted and untrusted and can be used to support MA PDU sessions using such networks in combination with a PLMN.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1-29. (canceled)

30. A communications method, the method comprising:
receiving, at an Access and Mobility Management Function (AMF) a first Protocol Data Unit (PDU) session establishment request from a User Equipment (UE) said first PDU session establishment request including a first PDU session ID number; and
sending, to the UE, first PDU session establishment information for the first PDU session identified by the first PDU session ID number and information indicating that non-3GPP (N3GPP) path switching is supported.

31. The method of claim 30, wherein the first PDU session establishment request is communicated via a first N3GPP access network.

32. The method of claim 31, wherein the first PDU session establishment information includes a first link specific address to be used by the UE for communication via the first N3GPP access network.

33. The method of claim 32, wherein said first PDU session establishment information is sent to the UE from the AMF via the first N3GPP access network.

34. The method of claim 30, wherein said information indicating that non-3GPP N3GPP path switching is supported indicates that switching between two different N3GPP paths is supported.

35. The method of claim 33, further comprising:
receiving at the AMF a second PDU session establishment request from the UE communicated via a second N3GPP access network, said second PDU session establishment request including the first PDU session ID number.

36. The method of claim 35, further comprising:
determining that the second PDU session establishment request is for a session for which a user plane data path already exists; and
sending, from the AMF to a session management function (SMF) a path switch message including the first session ID and indicating that that a second user plane data path is to replace the existing user plane data path for the first session.

37. The method of claim 36, wherein the first user plane data path is via the first N3GPP access network and wherein the second user plane data path is via the second N3GPP access network.

38. The method of claim 36, further comprising:
operating the SMF to send a message to a user plane function (UPF) indicating to the UPF that it should implement an Access Traffic Steering Switching and Splitting (ATSSS) function relating to the first session.

39. The method of claim 38, wherein said message to the UPF indicates that a second tunnel via the second N3GPP access network should be used to replace a first tunnel via the first N3GPP access network for the user plane of the first session.

40. The method of claim 38, operating the UPF, as part of implementing the ATSSS function in response to the message from the SMF, to:
generate a second link specific address for the second user plane data path; and
send a session establishment response to the SMF providing the second link specific address to be used for said first session when communicating via the second N3GPP access network.

41. The method of claim 35, further comprising:
sending, from the AMF to the first N3GPP access network a context release message instructing the first N3GPP access network to release resources at the first N3GPP access network which were used to support the first PDU session corresponding to said PDU session ID number.

42. The method of claim 41, further comprising:
receiving at the AMF, prior to sending said context release message, a release response message corresponding to the first PDU session conducted via the first NG3PP access network after successful establishment of a PDU data plane via the second N3GPP access network for the session identified by said first PDU session ID number.

43. A communications system, the system comprising:
an Access and Mobility Function (AMF) comprising:
a first receiver; a
a first transmitter; and
a first processor configured to operate the AMF to:
receive, a first Protocol Data Unit (PDU) session establishment request from a User Equipment (UE), said first PDU session establishment request including a first PDU session ID number; and
send to the UE, first PDU session establishment information for the first PDU session identified by the first PDU session ID number and information indicating that non-3GPP (N3GPP) path switching is supported.

44. The communications system of claim 43, wherein the first PDU session establishment request is communicated via a first N3GPP access network.

45. The communications system of claim 44, wherein the first PDU session establishment information includes a first link specific address to be used by the UE for communication via the first N3GPP access network.

46. A method of operating a user device (UE) comprising:
sending to an Access and Mobility Management Function (AMF) of a Public Land Mobile Network (PLMN) which provides service to the UE, a first registration message;
receiving from the AMF a registration accept message;
generating, at the UE, a first PDU session identifier (ID);
sending a first Protocol Data Unit (PDU) session establishment request to the AMF, said first PDU session establishment request including the first PDU session ID; and
receiving from the AMF, first PDU session establishment information including information indicating that N3GPP path switching is supported.

47. The method of claim 46, wherein sending the first registration message includes sending the first registration message via a first N3GPP access network.

48. The method of claim 47, wherein the registration accept message includes first Global Unique Temporary Identifier (GUTI) assigned by the PLMN to the UE.

49. The method of claim 48, wherein sending the first PDU session establishment request includes sending the first PDU session establishment request via the first N3GPP access network.

50. The method of claim 49, wherein the first PDU session establishment information is communicated via the first N3GPP access network to the UE and includes a first link specific address to be used by the UE for communication via the first N3GPP network for the first PDU session corresponding to the first PDU session ID.

51. The method of claim 46, wherein said information indicating that N3GPP path switching is supported indicates that N3GPP path switching is supported between different N3GPP networks.

52. The method of claim 49, further comprising:
establishing a first user plane data path for a communications session corresponding to the first session identifier via the first N3GPP access network.

53. The method of claim 49, further comprising:
sending a second PDU session establishment request to the AMF via a second N3GPP access network, said second PDU session establishment request including the first PDU session ID number.

54. The method of claim 52, further comprising:
receiving via the second N3GPP access network, from the AMF, second PDU session establishment information including a second link specific address and Access Traffic Steering Switching and Splitting (ATSSS) information indicating that N3GPP path switching is supported.

55. The method of claim 53, further comprising:
establishing a second user plane data path via the second N3GPP access network for the ongoing communications session corresponding to the first session ID.

56. The method of claim 55, further comprising:
deciding, following establishment of the second user plane data path via the second N3GPP access network to initiate de-registration with regard to the first traffic data path established through the first N3GPP access network following receipt of the second PDU session establishment information and establishment of the second user plane data path; and
sending a de-registration message to the AMF to initiate deregistration with respect to the first N3GPP access network.

57. A user device (UE) comprising:
at least one wireless receiver;
at least one wireless transmitter; and
a processor configured to:
operate the UE to send, to an Access and Mobility Management Function (AMF) of a Public Land Mobile Network (PLMN) which provides service to the UE, a first registration message;
operate the UE to receive from the AMF a registration accept message;
generate, at the UE, a first PDU session identifier (ID);
operate the UE to send a first Protocol Data Unit (PDU) session establishment request to the AMF, said first PDU session establishment request including the first PDU session ID; and
operate the UE to receive from the AMF, first PDU session establishment information indicating that non-3GPP (N3GPP) path switching is supported.

58. The UE of claim 57, wherein operating the UE to send the first registration message includes operating the UE to send the first registration message via a first N3GPP access network.
